(19) United States
(12) Patent Application Publication
(10) Pub. No.: US 2019/0304275 A1
(43) Pub. Date: Oct. 3, 2019

(54) CONTROL DEVICE AND MONITORING SYSTEM

(71) Applicant: KYOCERA Document Solutions Inc., Osaka (JP)

(72) Inventor: Kosuke TAKI, Osaka-shi (JP)

(73) Assignee: KYOCERA Document Solutions Inc., Osaka (JP)

(21) Appl. No.: 16/364,009

(22) Filed: Mar. 25, 2019

(30) Foreign Application Priority Data
Mar. 29, 2018 (JP) 2018-063967

(51) Int. Cl. G08B 13/196

(52) U.S. Cl. CPC G08B 13/19682; G08B 13/1961; G08B 13/19691

(57) ABSTRACT

An imaging device of a monitoring system generates captured image data indicating a captured image including a detection target. An input section of a control device of the monitoring system receives a first input indicating a first position on or in the vicinity of the detection target in the captured image and a second input indicating a second position farther from the detection target than the first position. A first setting section sets a first detection range defined by a boundary surrounding the detection target. A second setting section sets a second detection range defined by a boundary surrounding the first detection range. A third setting section sets a third detection range defined by a boundary located outside the first detection range and inside the second detection range. A monitoring controller controls monitoring of a specific event within the second detection range or the third detection range.

### INCORPORATION BY REFERENCE

The present application claims priority under 35 U.S.C. §119 to Japanese Patent Application No. 2018-063967, filed on Mar. 29, 2018. The contents of this application are incorporated herein by reference in their entirety.

### BACKGROUND

The present disclosure relates to a control device and a monitoring system.

In recent years, more monitoring systems have been introduced for crime deterrent, accident prevention, and the like. Particularly, a number of monitoring systems are installed in a facility accessible by unknown individuals, such as a hotel, a commercial building, a convenience store, a financial institution, a freeway, and a railroad. A monitoring system captures images of a monitoring target person or a monitoring target vehicle with a camera and transmits captured image data generated through the image capture to a monitoring center such as an administrative office or a security office. Monitoring personnel monitors the captured images. The captured images are recorded as desired or needed.

In some cases of monitoring of a captured image, it is necessary to preset parameters for a detection process of detecting a change in the captured image. In order to assist setting of such parameters, for example, a proposed image processing device displays an image corresponding to a size of a detection target object over an image of a range of the detection process.

### SUMMARY

A control device according to an aspect of the present disclosure includes a data acquisition section, an input section, a first setting section, a second setting section, and a third setting section. The data acquisition section acquires captured image data indicating a captured image obtained through image capture with respect to an area including a detection target. The input section receives a first input indicating a first position on or in the vicinity of the detection target in the captured image and a second input indicating a second position farther from the detection target than the first position. The first setting section sets a first detection range defined by a boundary surrounding the detection target exhibited by the captured image based on the first input. The second setting section sets a second detection range defined by a boundary surrounding the detection target exhibited by the captured image based on the second input. The boundary of the second detection range surrounds the first detection range. The third setting section sets a third detection range defined by a boundary surrounding the detection target exhibited by the captured image. The boundary of the third detection range is located outside the first detection range and inside the second detection range.

A monitoring system according to another aspect of the present disclosure includes an imaging device and a control device. The imaging device generates captured image data indicating a captured image obtained through image capture with respect to an area including a detection target. The control device includes an input section, a first setting section, a second setting section, a third setting section, and a monitoring controller. The input section receives a first input indicating a first position on or in the vicinity of the detection target in the captured image and a second input indicating a second position farther from the detection target than the first position. The first setting section sets a first detection range defined by a boundary surrounding the detection target exhibited by the captured image based on the first input. The second setting section sets a second detection range defined by a boundary surrounding the detection target exhibited by the captured image based on the second input. The boundary of the second detection range surrounds the first detection range. The third setting section sets a third detection range defined by a boundary surrounding the detection target exhibited by the captured image. The boundary of the third detection range is located outside the first detection range and inside the second detection range. The monitoring controller determines presence or absence of a specific event on an image within the second detection range or on an image within the third detection range.

### BRIEF DESCRIPTION OF THE DRAWINGS

FIG. 1 is a block diagram of a monitoring system according to a first embodiment of the present disclosure.

FIG. 2 is a schematic illustration of a plurality of detection ranges set on an image captured in the monitoring system according to the first embodiment.

FIG 3 is a schematic illustration of a plurality of detection ranges set by another method in an image captured in the monitoring system according to the first embodiment.

FIG. 4 is a flowchart illustrating a monitoring process that is performed by the monitoring system according to the first embodiment.

FIG. 5 is a flowchart illustrating a first entry detection process in the monitoring process according to the first embodiment.

FIG. 6 is a block diagram of a monitoring system according to a second embodiment of the present disclosure.

FIG. 7 is a schematic illustration of a plurality of detection ranges set on a top image captured in the monitoring system according to the second embodiment.

FIG. 8 is a flowchart illustrating a monitoring process that is performed by the monitoring system according to the second embodiment.

FIG. 9 is a flowchart illustrating a second entry detection process in the monitoring process according to the second embodiment.

### DETAILED DESCRIPTION

The following describes a monitoring system according to embodiments of the present disclosure with reference to the accompanying drawings. Elements that are the same or equivalent are indicated by the same reference signs in the drawings and description thereof is not repeated.

### First Embodiment

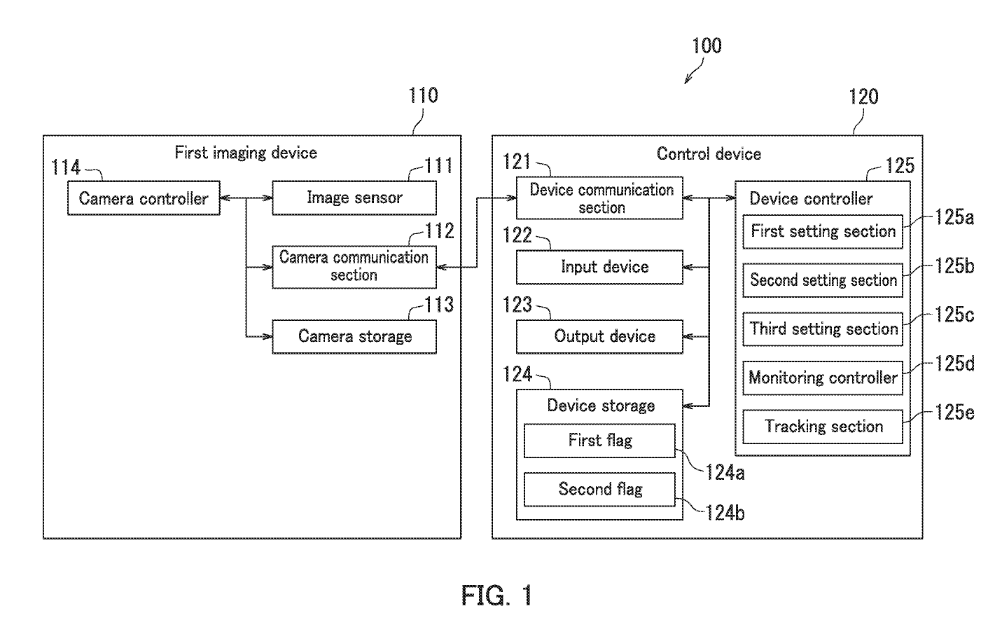

The following describes a monitoring system 100 according to a first embodiment with reference to FIG. 1. FIG. 1 is a block diagram of the monitoring system 100 according to the first embodiment.

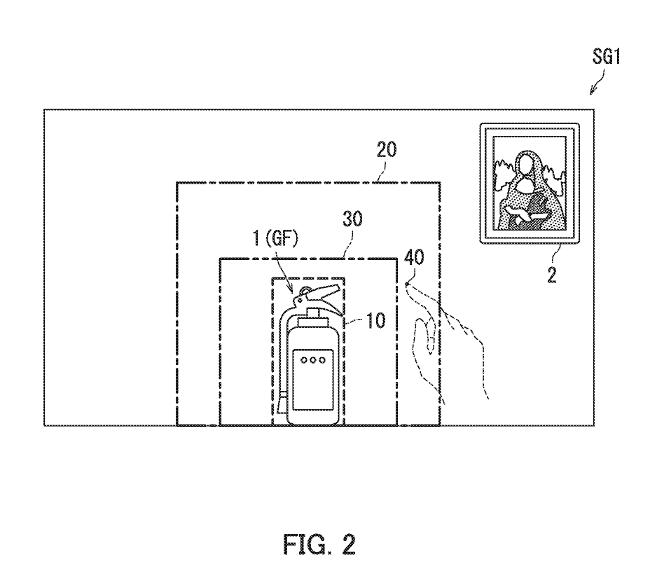

The monitoring system 100 includes a first imaging device 110 and a control device 120. The first imaging device 110 captures an image of an imaging area including a detection target to generate captured image data indicating the captured image. The image captured by the first imaging device 110 may be video or still. The control device 120 controls the first imaging device 110. The control device 120 also assists a user in setting a plurality of detection ranges (for example, a first detection range 10, a second detection range 20, and a third detection range 30 illustrated in FIG. 2 described below) in the captured image, which is a monitoring target.

The first imaging device 110 includes an image sensor 111, a camera communication section 112, camera storage 113, and a camera controller 114.

The image sensor 111 captures an image of the imaging area. The image sensor 111 generates data indicating the captured image and transmits the data to the camera controller 114. The data indicating the captured image is referred to below as “captured image data”. The image sensor III is for example a charge coupled device (CCD) image sensor or a complementary metal oxide semiconductor (CMOS) image sensor.

The camera communication section 112 is capable of communicating with an electronic device equipped with a communication device that uses the same communication method (protocol). The camera communication section 112 communicates with the control device 120 through a network such as a local area network (LAN). The camera communication section 112 is for example a communication module (communication device) such as a LAN board. The camera communication section 112 transmits the captured image data to the control device 120 in response to an instruction from the camera controller 114.

The camera storage 113 stores various data therein. The camera storage 113 includes semiconductor memory. The semiconductor memory for example includes random-access memory (RAM) and read-only memory (ROM). The camera storage 113 may have a function of storing the captured image data equivalent to a specific period of time.

The camera controller 114 controls operation of each section of the first imaging device 110 by executing a camera control program stored in the camera storage 113. The camera controller 114 includes a processor. The processor may include a central processing unit (CPU). Alternatively, the processor may include a microcomputer. Alternatively, the processor may include an application specific processing unit.

The camera controller 114 transmits the captured image data to the control device 120 through the camera communication section 112. The camera controller 114 may transmit the captured image data generated in real time. The camera controller 114 may alternatively transmit the captured image data stored in the camera storage 113 in response to a transmission request from the control device 120.

The camera controller 114 may further have a time acquisition section (not shown). The camera controller 114 may use a time acquired by the time acquisition section as a time stamp of the captured image data. The time acquisition section may measure time by itself. For example, the time acquisition section may include a real-time clock. The time acquisition section does not need to measure time by itself For example, the time acquisition section may receive data indicating time from an external device through the camera communication section 112. Specifically, the time acquisition section may for example receive data indicating time from the control device 120 through the device communication section 121 and the camera communication section 112.

The control device 120 includes a device communication section 121, an input device 122, an output device 123, device storage 124, and a device controller 125. The control device 120 is for example a server.

The device communication section 121 is capable of communicating with an electronic device equipped with a communication device that uses the same communication method (protocol). The device communication section 121 communicates with the camera communication section 112 through the network such as a LAN. The device communication section 121 is for example a communication module (communication device) such as a LAN board. The device communication section 121 receives the captured image data from the camera communication section 112.

The input device 122 receives an instruction to the control device 120 from the user. The input device 122 according to the first embodiment includes a keyboard and a mouse. Alternatively, the input device 122 includes a touch sensor.

The output device 123 outputs the captured image based on the captured image data received by the device communication section 121. The output device 123 also displays a plurality of detection ranges in a detection range setting process prior to a monitoring process. The output device 123 according to the first embodiment has a display. The display for example includes a liquid-crystal display. Note that the control device 120 may include an input/output device having functions of the input device 122 and the output device 123. The input/output device includes a liquid-crystal display with a touch panel.

The device storage 124 stores therein the captured image data received from the first imaging device 110 and various other data. The device storage 124 includes a storage device and semiconductor memory. The storage device for example includes either or both of a hard disk drive (HDD) and a solid state drive (SSD). The semiconductor memory for example includes RAM and ROM. The device storage 124 is an example of what may be referred to as storage.

The device storage 124 stores the captured image data received from the first imaging device 110 through the device communication section 121. The device storage 124 also stores values of a first flag 124a and a second flag 124b. A monitoring controller 125d of the device controller 125 controls the values of the first flag 124a and the second flag 124b.

The first flag 124a is set by the monitoring controller 125d. The monitoring controller 125d sets the first flag 124a to a value indicating “ON” upon determining that a person has entered the second detection range 20. The monitoring controller 125d also sets the first flag 124a to a value indicating “OFF” upon determining that the person has exited the second detection range 20. For example, the value indicating “ON” is “1”, and the value indicating “OFF” is “0”.

The second flag 124b is set by the monitoring controller 125d. The monitoring controller 125d sets the second flag 124b to a value indicating “ON” upon determining that the person has entered the third detection range 30. The monitoring controller 125d also sets the second flag 124b to a value indicating “OFF” upon determining that the person has exited the third detection range 30.

The device controller 125 includes a first setting section 125a, a second setting section 125b, a third setting section 125c, the monitoring controller 125d, and a tracking section 125e. The device controller 125 controls operation of each section of the control device 120 by executing a device control program stored in the device storage 124. The device controller 125 includes a processor. The processor includes a microcomputer. Alternatively, the processor may include an application specific processing unit. The device communication section 121, the device storage 124, and the device controller 125 are an example of what may be referred to as a data acquisition section.

The first setting section 125a sets the first detection range 10, which is defined by a boundary closely surrounding a detection target, based on an input indicating a position of a single tap received from the user. The position of the single tap received from the user is referred to below as a “first position”. The term “single tap” as used herein means a single-touch input performed on a touch panel screen.

The second setting section 125b sets the second detection range 20, which is defined by a boundary surrounding the detection target and surrounding the first detection range 10, based on an input indicating a position of a double tap received from the user. The position of the double tap received from the user is referred to below as a “second position”. The term “double tap” as used herein means a double-touch input performed on a touch panel screen.

The third setting section 125c sets the third detection range 30, which is defined by a boundary located outside the first detection range 10 and inside the second detection range 20, based on an input indicating a position of a midway tap received from the user. The position of the midway tap received from the user is referred to below as a “third position”. The term “midway tap” as used herein means a single-touch input performed on an area outside the first detection range 10 and inside the second detection range 20 while the first detection range 10 and the second detection range 20 are displayed on a touch panel screen.

The monitoring controller 125d determines presence or absence of a specific event on an image within the second detection range 20 or on an image within the third detection range 30. The monitoring controller 125d also specifies a tracking target when the specific event is present on the image within the third detection range of the captured image. The term “specific event” as used herein means for example an event such as trespassing of a person in a restricted area, removal of equipment, an article left unattended, and staying longer than a specific period of time.

The monitoring controller 125d sets the first flag 124a to “ON” upon determining that a person has entered the second detection range 20 of the captured image and sets the first flag 124a to “OFF” upon determining that the person has exited the second detection range 20. The monitoring controller 125d sets the second flag 124b to “ON” upon determining that the person has entered the third detection range 30 of the captured image and sets the second flag 124b to “OFF” upon determining that the person has exited the third detection range 30,

The tracking section 125e performs a tracking process on the tracking target specified by the monitoring controller 125d on the captured image. The following describes the monitoring system 100 in detail with reference to FIGS. 2 to 5. FIG. 2 is a schematic illustration of a plurality of detection ranges set in a captured image SG1 obtained in the monitoring system 100 according to the first embodiment. FIG. 2 shows an image 1 exhibiting a fire extinguisher (a fire extinguisher image GF) and an image 2 exhibiting a figure painting. The fire extinguisher is an example of the detection target. FIG. 2 further shows the first detection range 10, the second detection range 20, the third detection range 30, and a third position 40. The first detection range 10, the second detection range 20, and the third detection range 30 are an example of the plurality of detection ranges.

In FIG. 2, the first detection range 10 is represented by dashed lines, the second detection range 20 is represented by dashed and dotted lines, and the third detection range 30 is represented by dashed and double dotted lines. The third position 40 in FIG. 2 indicates a position of the midway tap received from the user. Note that the captured image SG1 in FIG. 2 only shows the images 1 and 2 before the first detection range 10, the second detection range 20, and the third detection range 30 are set.

Upon receiving an input of a single tap performed on the image 1 from the user through the input device 122, the device controller 125 instructs the first setting section 125a to set the first detection range 10 in FIG. 2. Upon receiving an input of a double tap performed around the image 1 from the user through the input device 122 after the single tap, the device controller 125 instructs the second setting section 125b to set the second detection range 20. Upon receiving an input of a midway tap from the user through the input device 122 after the double tap, the device controller 125 instructs the third setting section 125c to set the third detection range 30.

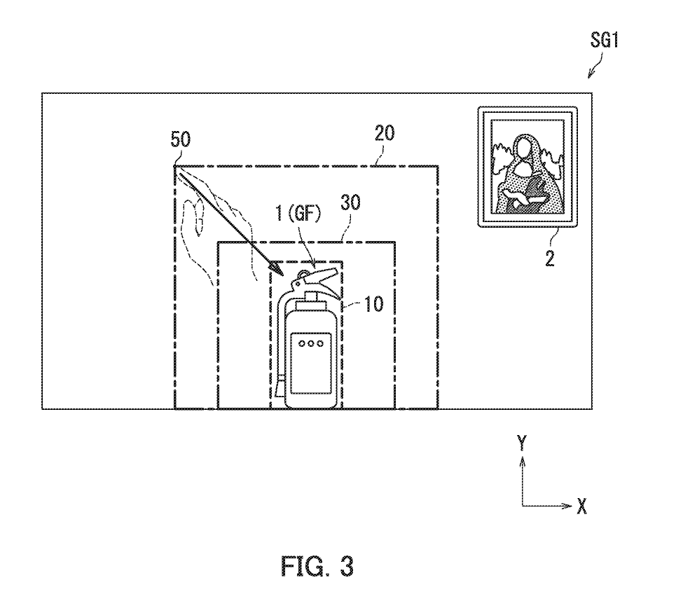

FIG. 3 is a schematic illustration of a plurality of detection ranges set by another method in the captured image SG1 obtained in the monitoring system 100 according to the first embodiment. FIG. 3 shows a drag start position 50 indicating a point where a drag operation starts and an arrow indicating a direction of the drag operation. Note that also in FIG. 3, only the images 1 and 2 are shown before the detection ranges are set.

Upon an input including a touch on a certain position (the drag start position 50) followed by a downward and rightward drag operation that is ended in the vicinity of the image 1 in FIG. 3 from the user through the input device 122, the device controller 125 determines that an input equivalent to the single tap, the double tap, and the midway tap described with reference to FIG. 2 has been received, and sets the first detection range 10, the second detection range 20, and the third detection range 30.

Specifically, the device controller 125 takes the touch on the drag start position 50 to be an input equivalent to the double tap to specify the second position. The device controller 125 then takes the end of the drag operation in the vicinity of the image 1 to be an input equivalent to the single tap to specify the first position. The device controller 125 sets the first detection range 10 based on the specified first position and sets the second detection range 20 based on the specified second position. The device controller 125 further determines a position of the third detection range 30 to be set around the first detection range 10 and inside the second detection range 20 in accordance with a predetermined arithmetic expression.

For example, the device controller 125 positions the third detection range 30 such that X-axis ends of the third detection range 30 are located between X-axis ends of the first detection range 10 and X-axis ends of the second detection range 20 as illustrated in FIG. 3. At the same time, the device controller 125 positions the third detection range 30 such that one Y-axis end of the third detection range 30 coincides with one Y-axis end of the first detection range 10 and one Y-axis end of the second detection range 20. At the same time, the device controller 125 positions the third detection range 30 such that a distance between the other Y-axis end of the third detection range 30 and the other Y-axis end of the second detection range 20 is three times longer than a distance between the other Y-axis end of the third detection range 30 and the other Y-axis end of the first detection range 10.

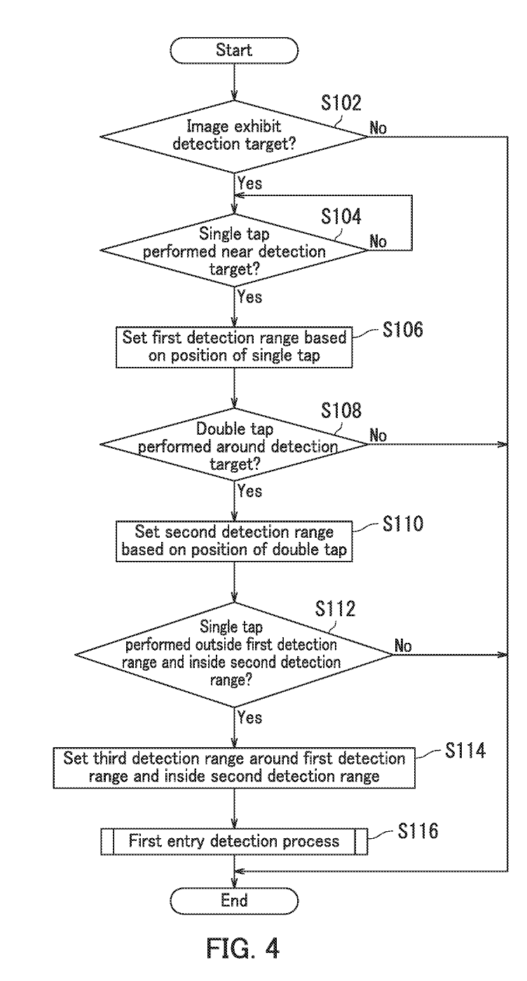

FIG. 4 is a flowchart illustrating the monitoring process that is performed by the monitoring system 100 according to the first embodiment.

First, as illustrated in FIG. 4, the device controller 125 determines whether or not a captured image acquired through the device communication section 121 exhibits a detection target (Step S102). The device controller 125 may receive an instruction from a user who has confirmed that the captured image exhibits the detection target. Upon the device controller 125 determining that the captured image acquired through the device communication section 121 exhibits the detection target (Yes in Step S102), the process proceeds to Step S104. Upon the device controller 125 determining that the captured image acquired through the device communication section 121 does not exhibit the detection target (No in Step S102), the monitoring process ends.

Next, the device controller 125 determines whether or not an input of a “single tap” performed on or in the vicinity of the detection target has been received from the user through the input device 122. (Step S104). Upon determining that an input of a “single tap” has been received from the user (Yes in Step S104), the device controller 125 instructs the first setting section 125a to set the first detection range. Upon determining that an input of a “single tap” has not been received from the user (No in Step S104), the device controller 125 waits until an input of a “single tap” is received from the user.

In response to the instruction from the device controller 125, the first setting section 125a specifies an outline of the detection target and sets the first detection range 10 based on the position of the single tap (Step S106).

Next, the device controller 125 determines whether or not an input of a “double tap” performed around the detection target has been received from the user through the input device 122 (Step S108). Upon determining that an input of a “double tap” has been received from the user (Yes in Step S108), the device controller 125 instructs the second setting section 125b to set the second detection range 20. Upon the device controller 125 determining that an input of a “double tap” has not been received from the user (No in Step S108), the monitoring process ends.

In response to the instruction from the device controller 125, the second setting section 125b sets the second detection range 20 larger than the first detection range 10 around the detection target based on the position of the double tap (Step S110).

Thereafter, the device controller 125 determines whether or not an input of a “midway tap” performed outside the first detection range 10 and inside the second detection range 20 has been received from the user through the input device 122 (Step S112). Upon determining that an input of a “midway tap” has been received from the user (Yes in Step S112), the device controller 125 instructs the third setting section 125c to set the third detection range 30. Upon the device controller 125 determining that an input of a “midway tap” has not been received from the user (No in Step S112), the monitoring process ends.

In response to the instruction from the device controller 125, the third setting section 125c sets the third detection range 30 around the first detection range 10 and inside the second detection range 20 based on the position of the midway tap (Step S114).

Thereafter, the device controller 125 instructs xe monitoring controller 125d to perform a “first entry detection process” (Step S116).

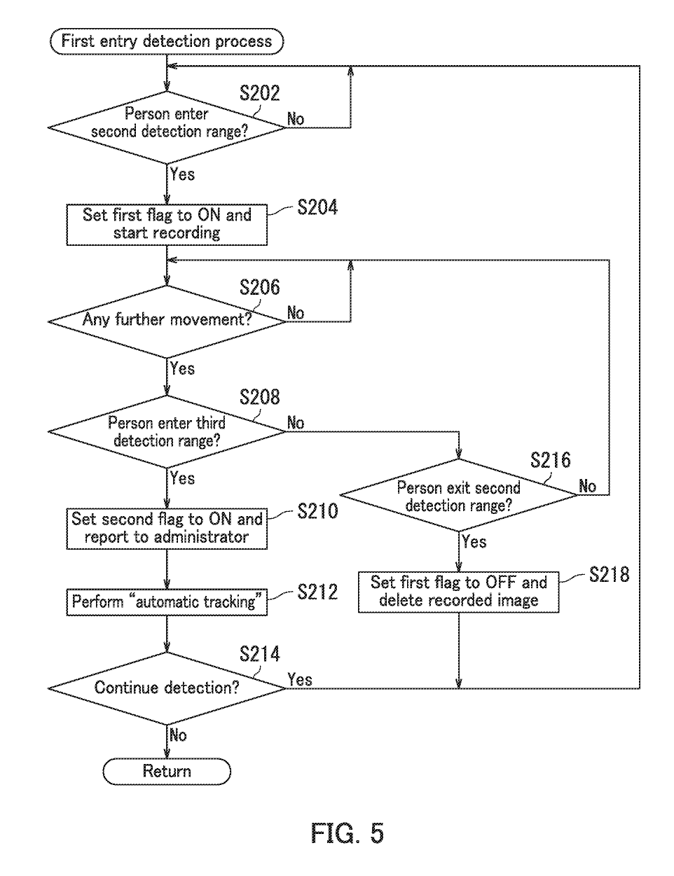

FIG. 5 is a flowchart illustrating the first entry detection process.

First, as illustrated in FIG. 5, the monitoring controller 125d periodically (for example, every 100 msec) determines whether or not a person has entered the second detection range 20 of the captured image SG1 (Step S202). Upon determining that a person has not entered the second detection range 20 (No in Step S202), the monitoring controller 125d continues the determination (Step S202).

Upon determining that a person has entered the second detection range 20 (Yes in Step S202), the monitoring controller 125d sets the first flag 124a to “ON” and starts recording the captured image SG1 (Step S204).

The monitoring controller 125d then determines whether or not there is any further movement in the captured image SG1 (Step S206). Upon determining that there is no further movement (No in Step S206), the monitoring controller 125d continues the determination (Step S206).

Upon determining that there is further movement in the captured image SG1 (Yes in Step S206) and the person has entered the third detection range 30 (Yes in Step S208), the monitoring controller 125d sets the second flag 124b to “ON” to report the entry to an administrator (Step S210). Thereafter, the device controller 125 instructs the tracking section 125e to perform “automatic tracking” (Step S212).

Upon determining that there is further movement in the captured image SG1 (Yes in Step S206) but the person has not entered the third detection range 30 (No in Step S208), the monitoring controller 125d determines whether or not the person has exited the second detection range 20 (Step S216). Upon determining that the person has exited the second detection range 20 (Yes in Step S216), the monitoring controller 125d sets the first flag 124a to “OFF” and deletes the recorded image (Step S218). Upon determining that the person has not exited the second detection range 20 (No in Step S216), the monitoring controller 125d returns the process to Step S206.

Through the above, the monitoring process including the process of setting a plurality of detection ranges that is performed by the monitoring system 100 has been described with reference to FIGS. 1 to 5. The monitoring system 100 can ease burdens on the user by assisting the user in setting a plurality of detection ranges in a monitoring target captured image.

### Second Embodiment

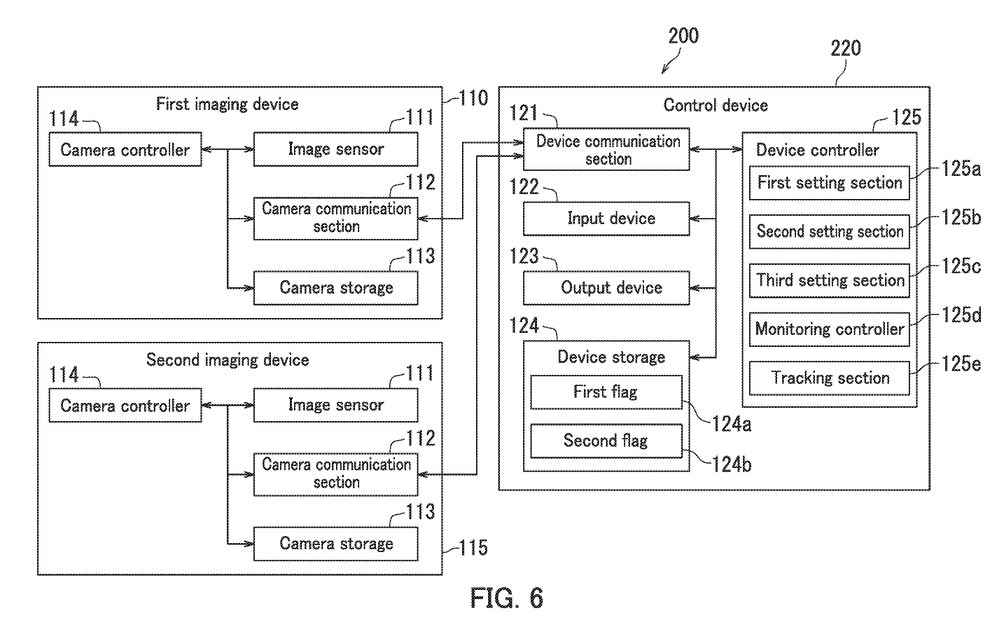

The following describes a monitoring system 200 with reference to FIGS. 6 to 9. The monitoring system 200 differs from the monitoring system 100 in that the monitoring system 200 sets a plurality of detection ranges in each of a front image captured by the first imaging device 110 and a top image captured by a second imaging device 115 whereas the monitoring system 100 sets a plurality of detection ranges in a single captured image.

The term “top image” as used herein means an image of an area including a detection target that is captured from above by the monitoring system 200 according to the second embodiment. The term “front image” as used herein means an image of the area including the detection target that is captured by the monitoring system 200 according to the second embodiment while the detection target is viewed along a horizontal direction. Description of the front image is omitted, because the captured image illustrated in FIG. 2, which has been described above, is the front image.

FIG. 6 is a block diagram of the monitoring system 200 according to the second embodiment. The monitoring system 200 includes the first imaging device 110, the second imaging device 115, and a control device 220. The second imaging device 115 has an equal function to the first imaging device 110. The first imaging device 110 captures an image of an imaging area including a detection target (for example, a fire extinguisher) while viewing the detection target along the horizontal direction to generate captured image data indicating a front image. The second imaging device 115 captures an image of the imaging area including the detection target from above to generate captured image data indicating a top image.

The control device 220 includes the device communication section 121, the input device 122, the output device 123, the device storage 124, and a device controller 225. The control device 220 is for example a server and has an equal or superior function to the control device 120. The control device 220 controls the first imaging device 110 and the second imaging device 115. The control device 220 also assists a user in setting a plurality of detection ranges (for example, first detection ranges 10 and 11, second detection ranges 20 and 21, and third detection ranges 30 and 31) in each of a front image and a top image, which are monitoring targets.

The device controller 25 includes a first setting section 225a, a second setting section 225b, a third setting section 225c, a monitoring controller 225d, and a tracking section 225e. The device controller 225 controls operation of each section of the control device 220 by executing a device control program stored in the device storage 124. The device controller 225 includes a processor. The processor includes a microcomputer. Alternatively, the processor may include an application specific processing unit. The device communication section 121, the device storage 124, and the device controller 125 are an example of what may be referred to as a data acquisition section.

The first setting section 225a, the second setting section 225b, the third setting section 225c, the monitoring controller 225d, and the tracking section 225e have an equal or superior function to the first setting section 125a, the second setting section 125b, the third setting section 125c, the monitoring controller 125d, and the tracking section 125e, respectively. The second embodiment differs from the first embodiment in that these sections target two captured images.

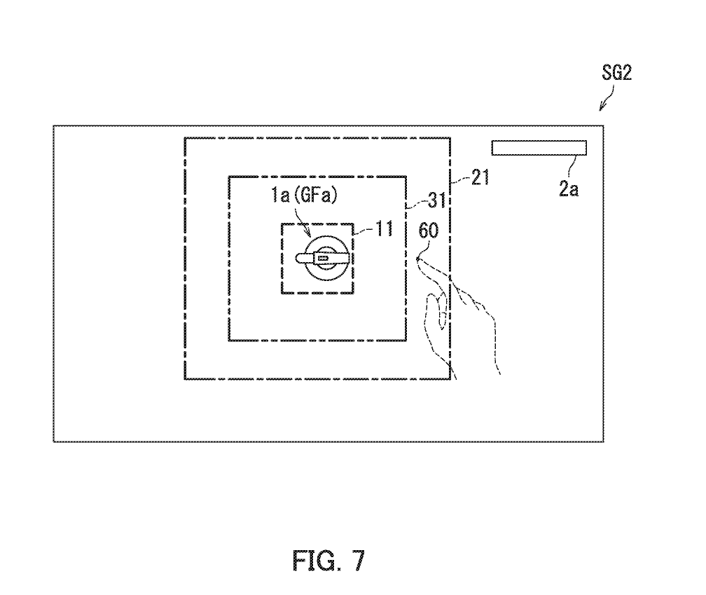

The following describes the monitoring system 200 in detail with reference to FIGS. 7 to 9.

FIG. 7 is a schematic illustration of a plurality of detection ranges set by another method in a top image captured in the monitoring system 200 according to the second embodiment. FIG. 7 shows an image 1a exhibiting a fire extinguisher (a fire extinguisher image GFa) and an image 2a exhibiting a figure painting. The fire extinguisher is an example of the detection target. FIG. 7 further shows the first detection range 11, the second detection range 21, the third detection range 31, and a third position 60. The first detection range 11, the second detection range 21, and the third detection range 31 are an example of the plurality of detection ranges. Note that the top image in FIG. 7 only shows the fire extinguisher image 1a and the figure painting image 2a before the detection ranges are set.

Upon receiving an input of a single tap performed on the fire extinguisher image 1a from the user through the input device 122, the device controller 225 instructs the first setting section 225a to set the first detection range 11 in FIG. 7. In FIG. 7, the first detection range 11 is represented by dashed bold lines. Upon receiving an input of a double tap performed around the fire extinguisher image 1a from the user through the input device 122 after the single tap. The device controller 225 instructs the second setting section 225b to set the second detection range 21. In FIG. 7, the second detection range 21 is represented by dashed and dotted bold lines. Upon receiving an input of a midway tap from the user through the input device 122 after the double tap, the device controller 225 instructs the third setting section 225c to set the third detection range 31. In FIG. 7, the third detection range 31 is represented by dashed and double dotted bold lines. Note that FIG. 7 schematically illustrates the midway tap being received from the user.

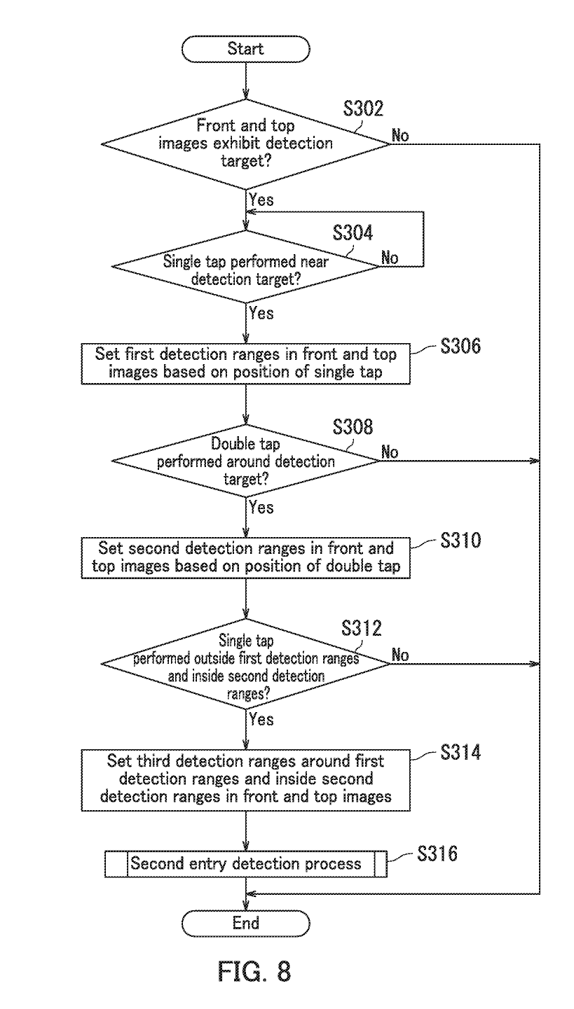

FIG. 8 is a flowchart illustrating a monitoring process that is performed by the monitoring system 200 according to the second embodiment.

First, as illustrated in FIG. 8, the device controller 225 determines whether or not a front image SG1 and a top image SG2 acquired through the device communication section 121 exhibit a detection target (Step S302). The device controller 225 may receive an instruction from a user who has confirmed that the front image SG-1 and the top image SG2 exhibit the detection target. Upon the device controller 225 determining that the front image SG1 and the top image SG2 acquired through the device communication section 121 exhibit the detection target (Yes in Step S302), the process proceeds to Step S304. Upon the device controller 225 determining that the front image SG-1 and the top image SG-2 acquired through the device communication section 121 do not exhibit the detection target (No in Step S302), the monitoring process ends.

Next, the device controller 225 determines whether or not an input of a “single tap” performed on or in the vicinity of the detection target has been received from the user through the input device 122 (Step S304). Upon determining that an input of a “single tap” has been received from the user (Yes in Step S304), the device controller 225 instructs the first setting section 225a to set the first detection ranges 10 and 11. Upon determining that an input of a “single tap” has not been received from the user (No in Step S304), the device controller 225 waits until art input of a. “single tap” is received from the user.

In response to the instruction from the device controller 225, the first setting section 225a specifies an outline of the detection target and sets the first detection ranges 10 and 11 based on the position of the single tap (Step S306). Next, the device controller 225 determines whether or not an input of a “double tap” performed around the detection target has been received from the user through the input device 122 (Step S308). Upon determining that an input of a “double tap” has been received from the user (Yes in Step S308), the device controller 225 instructs the second setting section 225b to set the second detection ranges 20 and 21. Upon the device controller 225 determining that an input of a “double tap” has not been received from the user (No in Step S308), the monitoring process ends.

In response to the instruction from the device controller 225, the second setting section 225b sets the second detection ranges 20 and 21 larger than the first detection ranges 10 and 11 around the detection target based on the position of the double tap (Step S310).

Thereafter, the device controller 225 determines whether or not an input of a “midway tap” performed outside the first detection ranges 10 and 11, and inside the second detection ranges 20 and 21 has been received from the user through the input device 122 (Step S312). Upon determining that an input of a “midway tap” has been received from the user (Yes in Step S312), the device controller 225 instructs the third setting section 225c to set the third detection ranges 30 and 31. Upon the device controller 225 determining that an input of a “midway tap” has not been received from the user (No in Step S312), the monitoring process ends.

In response to the instruction from the device controller 225, the third setting section 225c sets the third detection range 30 around the first detection range 10 and inside the second detection range 20, and the third detection range 31 around the first detection range 11 and inside the second detection range 21 based on the position of the midway tap (Step S314).

Thereafter, the device controller 225 instructs the monitoring controller 225d to perform a “second entry detection process” (Step S316).

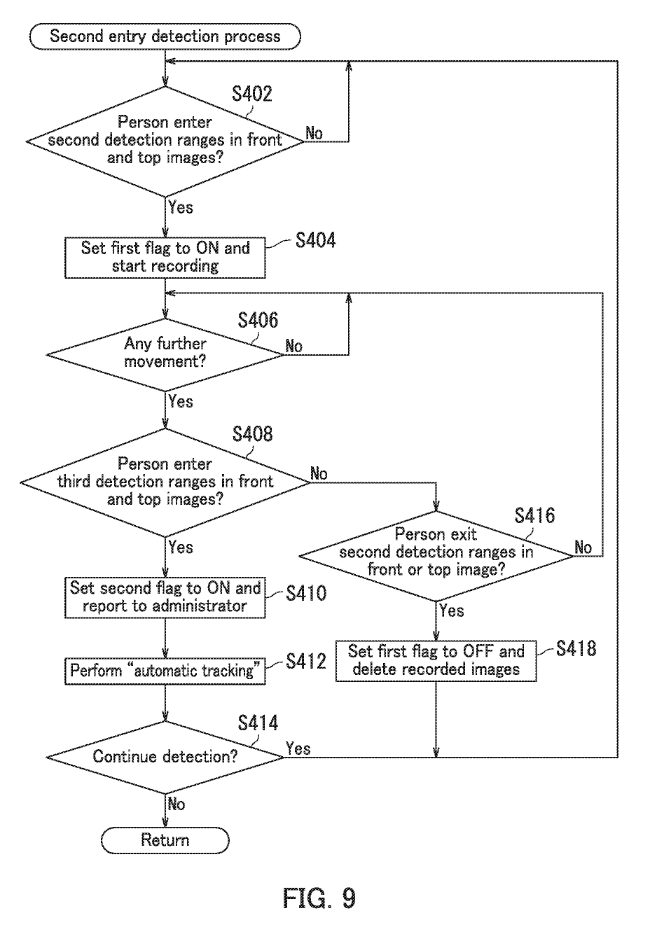

FIG. 9 is a flowchart illustrating the second entry detection process.

First, as illustrated in FIG. 9, the monitoring controller 225d periodically (for example, every 100 msec) determines whether or not a person has entered the second detection range 20 of the front image SG1 and the second detection range 21 of the top image SG2 (Step S402). Upon determining that a person has not entered the second detection ranges 20 and 21 (No in Step S402), the monitoring controller 225d continues the determination (Step S402).

Upon determining that a person has entered the second detection range 20 of the front image SG1 and the second detection range 21 of the top image SG2 (Yes in Step S402), the monitoring controller 225d sets the first flag 124a to “ON” and starts recording the front image SG1 and the top image SG2 (Step S404).

The monitoring controller 225d then determines whether or not there is any further movement in the front image SG1 and the top image SG2 (Step S406). Upon determining that there is no further movement (No in Step S406), the monitoring controller 225d continues the determination (Step S406).

Upon determining that there is further movement in the front image SG1 and the top image SG2 (Yes in Step S406) and the person has entered the third detection ranges 30 and 31 (Yes in Step S408), the monitoring controller 225d sets the second flag 124b to “ON” to report the entry to the administrator (Step S410). Thereafter, the device controller 225 instructs the tracking section 225e to perform “automatic tracking” (Step S412).

Upon determining that there is further movement in the front image SG1 and the top image SG2 (Yes in Step S406) but the person has not entered the third detection ranges 30 and 31 (No in Step S408), the monitoring controller 225d determines whether or not the person has exited the second detection ranges 20 and 21 (Step S416). Upon determining that the person has exited the second detection ranges 20 and 21 (Yes in Step S416), the monitoring controller 225d sets the first flag 124a to “OFF” and deletes the recorded images (Step S418). Upon determining that the person has not exited the second detection ranges 20 and 21 (No in Step S416), the monitoring controller 225d returns the process to Step S406.

Through the above, the monitoring process including the process of setting a plurality of detection ranges that is performed by the monitoring system 200 has been described with reference to FIGS. 6 to 9. The monitoring system 200 can ease burdens on the user by assisting the user in setting a plurality of detection ranges in a monitoring target front image and a monitoring target top image.

The first and second embodiments of the present disclosure have been described above with reference to the drawings (FIGS. 1 to 9). However, the present disclosure is not limited to the above embodiments and may be implemented in various different forms that do not deviate from the essence of the present disclosure. Furthermore, the configurations in the above embodiments are merely examples that do not impose any particular limitations and can be altered in various ways to the extent that there is not substantial deviation from the effects of the present disclosure. For example, the first imaging device 110 and the second imaging device 115 may have functions equivalent to those of the input device 122, the output device 123, the device storage 124, and the device controller 125 of the control device 120.

What is claimed is:

1. A control device comprising:
a data acquisition section configured to acquire captured image data indicating a captured image obtained through image capture with respect to an area including a detection target;
an input section configured to receive a first input indicating a first position on or in the vicinity of the detection target in the captured image and a second input indicating a second position farther from the detection target than the first position;
a first setting section configured to set a first detection range defined by a boundary surrounding the detection target exhibited by the captured image based on the first input;
a second setting section configured to set a second detection range defined by a boundary surrounding the detection target exhibited by the captured image based on the second input, the boundary of the second detection range surrounding the first detection range; and
a third setting section configured to set a third detection range defined by a boundary surrounding the detection target exhibited by the captured image, the boundary of the third detection range being located outside the first detection range and inside the second detection range.

2. The control device according to claim 1, further comprising:
an imaging device configured to capture an image of the area including the detection target to generate the captured image data; and
a monitoring controller configured to determine presence or absence of a specific event on an image within the second detection range or an image within the third detection range.

3. The control device according to claim 2, wherein
the imaging device generates captured image data indicating a front image of the area including the detection target and captured image data indicating a top image of the area including the detection target, the front image being captured while the detection target is viewed along a horizontal direction, the top image being captured from above, and
the monitoring controller:
determines presence or absence of the specific event on the image within the second detection range of the front image and on the image within the second detection range of the top image; or
determines presence or absence of the specific event on the image within the third detection range of the front image and on the image within the third detection range of the top image.

4. The control device according to claim 2, further comprising
storage configured to store the captured image data therein, wherein
the monitoring controller stores the captured image data in the storage upon determining the presence of the specific event on the image within the second detection range.

5. The control device according to claim 2, further comprising a tracking section, wherein
the monitoring controller specifies a tracking target upon determining the presence of the specific event on the image within the third detection range, and
the tracking section tracks the tracking target on the captured image.

6. A monitoring system comprising:
an imaging device configured to generate captured image data indicating a captured image obtained through image capture with respect to an area including a detection target; and
a control device, wherein
the control device includes:
an input section configured to receive a first input indicating a first position on or in the vicinity of the detection target in the captured image and a second input indicating a second position farther from the detection target than the first position;
a first setting section configured to set a first detection range defined by a boundary surrounding the detection target exhibited by the captured image based on the first input;
a second setting section configured to set a second detection range defined by a boundary surrounding the detection target exhibited by the captured image based on the second input, the boundary of the second detection range surrounding the first detection range;
a third setting section configured to set a third detection range defined by a boundary surrounding the detection target exhibited by the captured image, the boundary of the third detection range being located outside the first detection range and inside the second detection range; and
a monitoring controller configured to determine presence or absence of a specific event on an image within the second detection range or on an image within the third detection range.
